(19) United States
(12) Patent Application Publication
(10) Pub. No.: US 2005/0196588 A1
(43) Pub. Date: Sep. 8, 2005

(54) Electronic device

(75) Inventor: Tatsuya Suzuki, Tokho (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/061,311

(22) Filed: Feb. 18, 2005

Related U.S. Application Data
(63) Continuation of application No. PCT/JP04/18682, filed on Dec. 8, 2004.

(30) Foreign Application Priority Data
Dec. 8, 2003 (JP) P2003-409524

(51) Int. Cl. B27F 5/00; D06N 7/04; B32B 3/12; B32B 3/00; D03D 3/08

(52) U.S. Cl. 428/151; 428/161; 428/174; 428/159; 428/175

(57) ABSTRACT

This portable electronic device includes a covering member made of a wood piece which has been strengthened.

### PRIORITY CLAIM

This application is continuation application of a PCT Application No. PCT/JP2004/018682, filed Dec. 8, 2004, entitled “ELECTRONIC DEVICE” whose priority is claimed on Japanese Patent Application No. 2003-409524, filed Dec. 8, 2003. The content of both the PCT Application and Japanese Application is incorporated herein by reference.

### BACKGROUND OF THE INVENTION

1. Field of the Invention

The present invention relates to an electronic device which is operated by a user while being carried in his hand.

2. Description of Related Art

With a covering member for a device which is intended to be operated by a user while being held in his hand, such as a camera, a portable telephone, an IC recorder, a PDA, a remote control for a household electronic product such as a television, a video recorder, an air conditioner, a projector, or the like, in consideration of the mechanical aspect such as formability, solidity and corrosion resistance, and in consideration of the design aspect such as quality of appearance and designability, and from the point of view of the demands made by industrial mass production, it is normal for such a covering member to be made generally of a material which is suitable for mass production, like a synthetic resin such as ABS, polycarbonate, acryl or the like or a light metal such as aluminum, stainless steel, titanium, magnesium or the like.

A material such as a synthetic resin or a light metal is subject to the deficiency that, it may not be satisfactorily gripped by the human hand, since it does not absorb moisture. On the other hand, a natural material such as wood or bamboo or the like is endowed with an excellent feeling which appeals to the sensitivities, since it is excellent at absorbing moisture and is easily gripped in the hand. Wood as the natural material has many merits as follows.

1) Unlike a metal or the like, the wood does not give a cold feeling to user's hand, and does not stick to the hand, and does not generate the condensation on itself, even under conditions of low temperature.

2) In comparison with a metal or the like, a thermal conductivity of the wood is low, so that it does not transmit heat which is generated internally within the device to the user's hand.

3) When the user looks the grain of the wood, he obtains a emotional stability.

4) Some wood emits an aroma which has a healing benefit.

5) When the wood is used for the covering member of the sounding device, it creates a rich timbre just like the box of a loudspeaker.

In the Japanese Examined Patent Publication, Second Publication, No. H07-2326, there is disclosed a technique in which, with the objective of strengthening a wooden material, first this wooden material is softened by placing it in an atmosphere of steam at high temperature and high pressure, and thereafter this wooden material is compressed mechanically under the same atmospheric conditions.

In the Japanese Examined Patent Publication, Second Publication, No. H05-12125, there is disclosed a technique in which, with the objective of processing a wooden material three dimensionally, a raw wood is cut after having been heated up, a wooden material which has been cut from the raw wood is dried out, and thereafter this wooden material is formed into a desired shape by being put into molds.

In the Japanese Patent No. 3078452, there is disclosed a technique in which, with the objective of processing a wooden material three dimensionally, the wooden material softened by absorption of water is compressed and cut to be formed into a primary article, and the primary article is heated up, and have water absorbed in it, and then primary article is formed into a three dimensional shape and fixed.

In the Japanese Examined Patent Publication, Second Publication, No. H04-30883, there is disclosed a technique in which, with the objective of manufacturing a wooden component which has high strength, after drying of a wood, the core fibers of the wood are hardened, and then the wooden component is cut out from this hardened wood.

In the Japanese Unexamined Patent Publication, First Publication, No. H10-296706, there is disclosed a technique in which, with the objective of preventing cracking of a log, and of enhancing the ornamental appearances and the properties of a wooden material, a synthetic resin is incorporated into the log by impregnating and filling it with a dipping processing solution which includes vinyl monomers and polymers through polymerization of the solution, during the drying process.

### SUMMARY OF THE INVENTION

A portable electronic device which is operated while being held in a hand of a user comprising a covering member made of a wood piece which has been strengthened.

In the above electronic device of the present invention, it is preferable that the wood piece is be strengthened by compression.

In the above electronic device of the present invention, it is preferable that the wood piece is compressed after a high density portion of the wood piece has been made thin and a low density portion of the wood piece has been made thick.

In the above electronic device of the present invention, it is preferable that the wood piece is compressed after a portion of the wood piece at which high strength must be ensured has been made thicker than a surrounding portion thereof.

In the above electronic device of the present invention, it is preferable that the wood piece is compressed after another wood piece has been adhered to a portion of the wood piece at which high strength must be ensured.

In the above electronic device of the present invention, it is preferable that the direction of the grain of the wood piece and the direction of the grain of the another wood piece are different.

It is preferable that the above electronic device of the present invention further comprises another member which is harder than the wood piece and is disposed on a portion of the wood piece at which high strength must be ensured, wherein the wood piece is compressed together with the another member.

In the above electronic device of the present invention, it is preferable that the wood piece is strengthened by being integrated with a reinforcing member which is harder than the wood piece, in such a manner that the wood piece is superimposed upon the reinforcing member and is compressed therewith.

In the above electronic device of the present invention, it is preferable that the reinforcing member is of metal.

In the above electronic device of the present invention, it is preferable that the direction along which the reinforcing member extends and the direction of the grain of the wood piece cross one another.

In the above electronic device of the present invention, it is preferable that the reinforcing member is made in the form of a grating or a net.

In the above electronic device of the present invention, it is preferable that the reinforcing member is quenched.

In the above electronic device of the present invention, it is preferable that the wood piece is cut across its grain, and a synthetic resin is impregnated into a end surface of the wood piece which is formed by this cutting.

In the above electronic device of the present invention, it is preferable that the wood piece is strengthened by being impregnated with a synthetic resin.

In the above electronic device of the present invention, it is preferable that a carbonized layer is formed on a surface of the wood piece.

### BRIEF DESCRIPTION OF THE DRAWINGS

FIG. 1 is a figure for showing the first preferred embodiment of the present invention, and is a cross sectional view showing the construction of a camera which uses wood as covering members.

FIG. 2 is a cross sectional view showing a wood piece which is to be strengthened, and upper and lower molds for compressing the wood piece.

FIG. 3 is a cross sectional view showing the wood piece which is compressed by being sandwiched between the upper and lower molds.

FIG. 4 is a cross sectional view showing the wood piece which is strengthened by compression.

FIG. 5 is a figure for explanation of the second preferred embodiment of the present invention, and is a cross sectional view showing a wood piece whose thickness is made to vary according to the density of its grain.

FIG. 6 is a cross sectional view showing the wood piece in which the varied thicknesses thereof shown in FIG. 5 have been uniformed by compression so as to strengthen the wood piece.

FIG. 7 is a figure for explanation of the third preferred embodiment of the present invention, and is a cross sectional view showing a wood piece of which a portion for which high strength must be ensured is made thicker than its surroundings.

FIG. 8 is a cross sectional view showing the wood piece in which the varied thicknesses thereof shown in FIG. 7 have been uniformed by compression so as to strengthen the wood piece.

FIG. 9 is a figure for explanation of the fourth preferred embodiment of the present invention, and is a cross sectional view showing a wood piece to which, at a portion for which high strength must be ensured, another wedge of wood has been adhered.

FIG. 10 is a cross sectional view showing the wood piece which has been strengthened by compressing with another wedge of wood so as to strengthen the wood piece.

FIG. 11 is a figure for explanation of the fifth preferred embodiment of the present invention, and is a perspective view showing a wood piece which is to be strengthened, and another member which is adhered to a portion of this wood piece for which high strength must be ensured.

FIG. 12 is a cross sectional view showing the wood piece to which the another member is disposed at a portion for which high strength must be ensured.

FIG. 13 is a cross sectional view showing the wood piece which has been strengthened by compressing with the another member so as to strengthen the wood piece.

FIG. 14 is a figure for explanation of the sixth preferred embodiment of the present invention, and is a cross sectional view showing a wood piece to which rod shaped members made of metal are attached as reinforcing members.

FIG. 15 is a cross sectional view showing the wood piece which has been strengthened by compressing with the rod shaped members so as to strengthen the wood piece.

FIG. 16 is a figure showing a variant example of the above described sixth preferred embodiment, and is a perspective view showing a wood piece which uses a net made of metal as a reinforcing member.

FIG. 17 is a figure for explanation of the seventh preferred embodiment of the present invention, and is a cross sectional view showing a wood piece which has been strengthened as a whole by being impregnated with a synthetic resin after compression.

FIG. 18 is a figure for explanation of the eighth preferred embodiment of the present invention, and is a perspective view showing a wood piece which has been strengthened partially by being impregnated with a synthetic resin after compression.

FIG. 19 is a figure for explanation of the ninth preferred embodiment of the present invention, and is a cross sectional view showing a wood piece on the surface of which a carbonized layer has been formed.

FIG. 20 is a cross sectional view showing, as another example of application of the present invention, a remote control device of a household electrical product which utilizes wood as a covering member.

FIG. 21 is a perspective view showing, as yet another example of application of the present invention, a portable telephone fitted with a camera which utilizes wood as a covering member, and is a perspective view showing the portable telephone in its opened state.

FIG. 22 is a side view showing the portable telephone in its folded state.

### DETAILED DESCRIPTION OF THE INVENTION

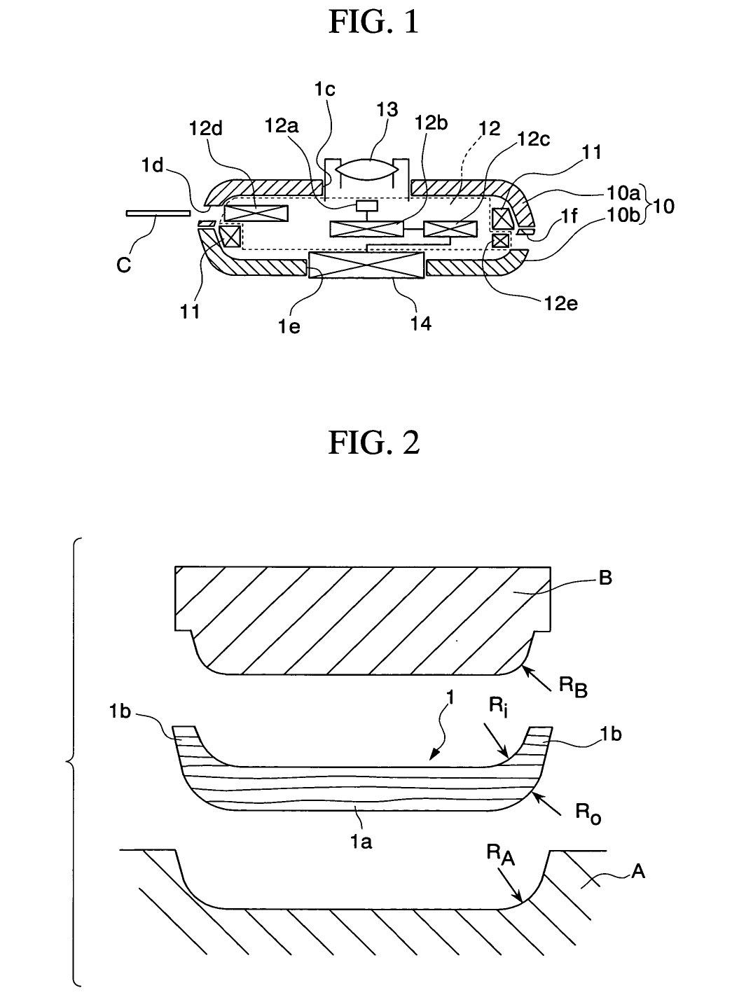

The first preferred embodiment of the present invention will be described with reference to FIG. 1 through FIG. 4.

FIG. 1 shows a digital camera, as an example of an electronic device which takes advantage of wood as covering members. The digital camera comprises a covering member 10, a frame 11 which supports the covering member 10, an internal mechanism 12, an imaging lens 13, and a liquid crystal monitor 14 which displays an image which has been taken in the visual field of the imaging lens 13. The covering member 10 consists of a front cover 10a and a rear cover 10b. In the front cover 10a, there are formed a circular shaped hole 1c for exposing the imaging lens 13 and a through hole 1d for an image recording medium C. In the rear cover 10b, there are formed a rectangular window portion 1e for exposing the liquid crystal monitor 14 and a through hole 1f for inserting a cable connected to a personal computer or the like. Apart from these features, holes are formed in the front cover 10a and in the rear cover 10b for allowing a release button and various buttons for operation to project through them. According to requirements, some or all of these various openings are provided with doors or caps and so on, although these features are not particularly shown in the drawings.

The internal mechanism 12 includes an imaging element 12a which consists of a CCD and the like, a drive circuit 12b for the imaging element 12a, a drive circuit 12c for the liquid crystal monitor 14, an image recording device 12d on an image recording medium C, a connection terminal 12e for a personal computer, and the like.

A wooden material that has been strengthened by being compressed is utilized for the front cover 10a and the rear cover 10b. The wood piece 1 which constitutes the basis for the front cover 10a is formed in a box shape in which a wall portion 1b extends around the periphery of a rectangular bottom portion 1a. Before this wood piece 1 is strengthened, it is processed by being cut out from a block shaped piece of raw wood, so that a smooth curved surface connects from its bottom portion 1a to its wall portion 1b. The grain of this wood piece 1 is oriented in the lengthwise direction along the bottom portion 1a, and in the thickness direction along the surrounding peripheral wall portion 1b.

It should be understood that, as the type for the wood piece 1, there may be suggested, for example, Japanese cypress, paulownia, teak, mahogany, cedar, pine, cherry, bamboo or the like. Furthermore it is possible to utilize, not only proper wood, but also a wooden substance like a material made by compressing waste wood chips or wood sawdust or the like.

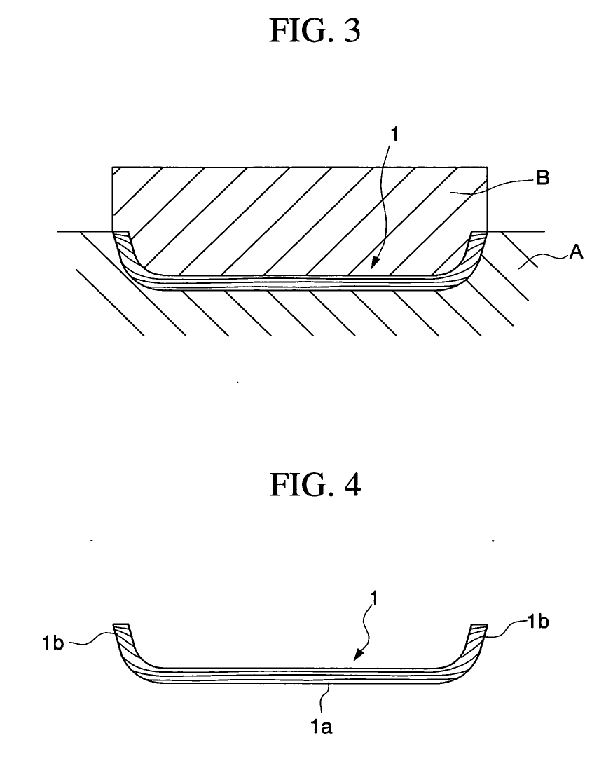

In the following, the various processes involved in strengthening the front cover 10a will be explained with reference to FIG. 2 and FIG. 3 (since the processes involved in strengthening the rear cover 10b are the same, their explanation will herein be curtailed).

First, the wood piece 1 is put into a steam atmosphere at high temperature and pressure. The wood piece 1 absorbs an excess water by being placed in a steam atmosphere at high temperature and high pressure, and accordingly softens.

Next, as shown in FIG. 2, still in a steam atmosphere at high temperature and high pressure the same as described above, the wood piece 1 is laid inside a lower mold A. Incidentally, the relationship between the shape of the lower surface of the wood piece 1 (its outer aspect) and the shape of the lower mold A, and the relationship between the shape of the upper surface of the wood piece 1 (its inner aspect) and the shape of an upper mold B will be explained. As described above, a smooth curved surface connects from the bottom portion 1a to the wall portion 1b of the wood piece 1. When the radius of curvature of the curve of the lower surface (the outer aspect) of the wood piece 1 is termed Ro, the radius of curvature of the curve of the upper surface (the inner aspect) of the wood piece 1 is termed Ri, the radius of curvature of the curved surface of the lower mold A which contacts the curved surface of radius of curvature Ro is termed RA, and the radius of curvature of the curved surface of the upper mold B which contacts the curved surface of radius of curvature Ri is termed RB, the relationships Ro>RA and Ri>RB hold between them.

Next, as shown in FIG. 3, the upper mold B is shifted so as to be fitted into the interior of the lower mold A, so that the wood piece 1 is compressed between the upper and lower molds A and B, and this state is kept for a predetermined time period. The wood piece 1 which has been sandwiched between the upper and lower molds A and B is compressed to from about ½ to about ⅓ of its original thickness by the acting of compression force on its bottom portion 1a and its wall portion 1b. At this time, at the wall portion 1b, based on the relationships of the radii of curvature as described above, a substantial compression force does not act along the direction of the grain, while a frictional force acts in the upward direction so as to rub the outer aspect of the wall portion 1b in the upward direction, and a frictional force also acts in the downward direction so as to rub the inner aspect of the wall portion 1b in the downward direction. The grain of the wall portion 1b which was originally laid down, is deformed so as to be curved around in the vertical direction.

Finally, when the high temperature and high pressure steam atmosphere is released and the wood piece 1 is taken out from the upper and lower molds A and B, the wood piece 1 is formed in the shape of the internal space which is defined when the molds A and B are fitted together. After the wood piece 1 has thus been compressed, its bottom portion 1a and its wall portion 1b are both of almost uniform thickness.

The wood piece 1 which has been strengthened in the above described manner is finally formed in the shape of the front cover 10a, as shown in FIG. 4. This wood piece 1 obtains a high strength as a whole because the density of the wood piece 1 increases by compression. In addition, since the strength of the wall portion 1b is borne by bending of the grain of the wall portion 1b in the vertical direction, it is possible to enhance the strength of the wall portion 1b to the same level as that of the other portions of the wood piece 1, and it is possible to ensure a sufficient strength for the covering member 10, without using a thick wood.

Therefore, it is possible to mass produce an electronic device of high quality which is excellent at absorbing moisture, and easy to grip in the hand, and has the excellent feeling which appeals to the sensitivities possessed by the natural material such as wood or bamboo.

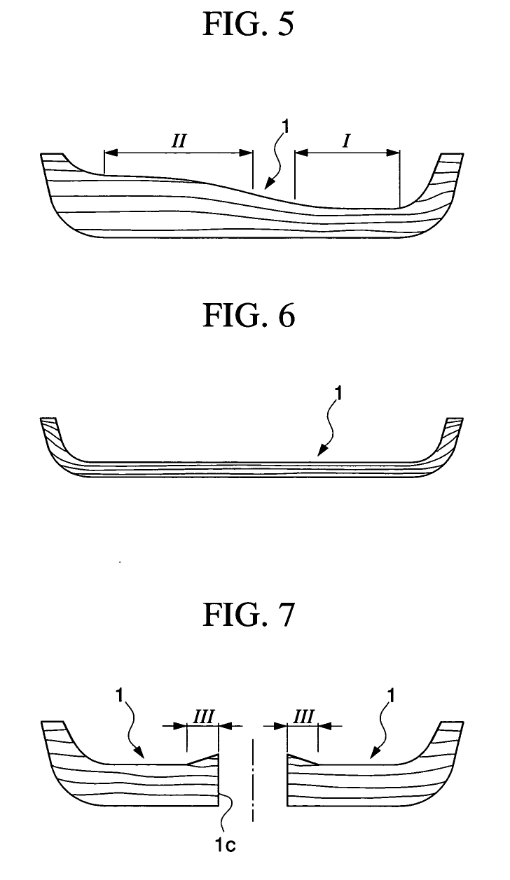

Next, the second preferred embodiment of the present invention will be explained with reference to FIG. 5 and FIG. 6. It should be understood that to structural elements which are the same as in the above described first preferred embodiment and which have already been explained, the same reference symbols are appended, and their explanation will be curtailed.

In this second preferred embodiment, in the state before compressing the wood piece 1 as shown in FIG. 5, a high density portion (denoted by I in the figure), in other words a portion of which the grain is tight, is made to be thin, while a low density portion (denoted by II in the figure), in other words a portion of which the grain is loose, is made to be thick. When a wood piece 1 with this above shape is strengthened according to the process which has been explained with reference to the above described first preferred embodiment, the wood piece 1 comes to be formed in a plate shape of almost uniform thickness as shown in FIG. 6. Looking at the wood piece 1 after compression, the compression ratio of the portion which originally had a high density is lower, while the compression ratio of the portion which originally had a low density is higher, so that, considering the wood piece I after compression as a whole, it has an almost uniform strength, since its density after compression is almost uniform.

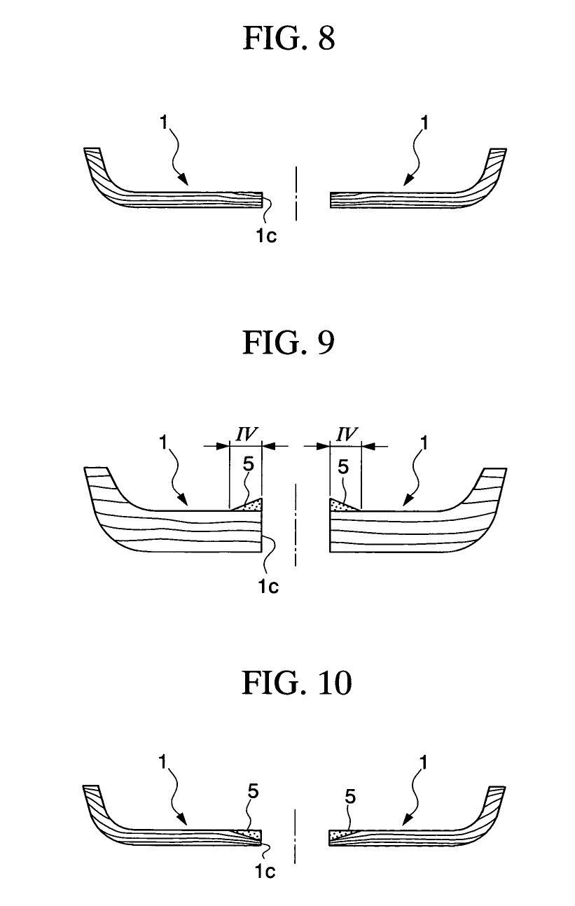

Next, the third preferred embodiment of the present invention will be explained with reference to FIG. 7 and FIG. 8. It should be understood that to structural elements which are the same as in the above described preferred embodiments and which have already been explained, the same reference symbols are appended, and their explanation will be curtailed.

In the wood piece 1 of this third preferred embodiment, an aperture 1c for exposing the imaging lens 13 is formed. In the state before compressing the wood piece 1, as shown in FIG. 7, a portion such as the edge around the hole 1c (denoted by III in the figure) for which it is required to ensure high strength, is formed to be thicker than portions which surround it. When a wood piece 1 with such shape is strengthened according to the process which has been explained with reference to the above described first preferred embodiment, the wood piece 1 comes to be formed in a plate shape of almost uniform thickness as shown in FIG. 8. Looking at the wood piece 1 after compression, the compression ratio of the portion which was originally made thicker than its surroundings is higher than that of its surroundings. Therefore, the portion which was originally made thicker than its surroundings obtains a higher strength.

Furthermore, although the wood piece 1 has been cut across its grain over almost the entire inner peripheral surface of the aperture 1c, so that cracking along its grain would occur easily if it had not been compressed but was in its original condition, since actually a high strength is imparted in the above described manner to this edge peripheral region of the aperture 1c, accordingly it is prevented from generating of a crack from this surface. Moreover, it is prevented from leaking out of sap from this surface which has been cut, which might otherwise cause a foul odor.

Next, the fourth preferred embodiment of the present invention will be explained with reference to FIG. 9 and FIG. 10. It should be understood that to structural elements which are the same as in the above described preferred embodiments and which have already been explained, the same reference symbols are appended, and their explanation will be curtailed.

In the wood piece 1 of this fourth preferred embodiment, an aperture 1c is formed, just as was the case with the above described third preferred embodiment. In the state before compressing the wood piece 1, as shown in FIG. 9, another wood piece 5 is adhered to a portion for which it is required to ensure high strength such as the edge around the hole 1c (denoted by IV in the figure). When a wood piece 1 as described above is strengthened according to the process which has been explained with reference to the above described first preferred embodiment, the wood piece 1 comes to be formed in a plate shape of almost uniform thickness as shown in FIG. 10. Looking at the wood piece 1 after compression, the compression ratio of the portion to which is adhered the another wood piece 5 is higher than that of its surroundings. Therefore, the portion to which is adhered another wood piece 5 obtains a higher strength.

Furthermore, it is prevented from generating of a crack from this surface, and it is prevented from leaking out of sap from this surface which has been cut, which might otherwise cause a foul odor.

In this fourth preferred embodiment, it is desirable to arrange for the grain of the wood piece 1 and the grain of the another wood piece 5 to be almost perpendicular to one another. Therefore, it is possible to ensure even higher strength for the resulting product, since these two wood pieces mutually reinforce one another in their respective directions where they are each weakest.

Next, the fifth preferred embodiment of the present invention will be explained with reference to FIG. 11 through FIG. 13. It should be understood that to structural elements which are the same as in the above described preferred embodiments and which have already been explained, the same reference symbols are appended, and their explanation will be curtailed.

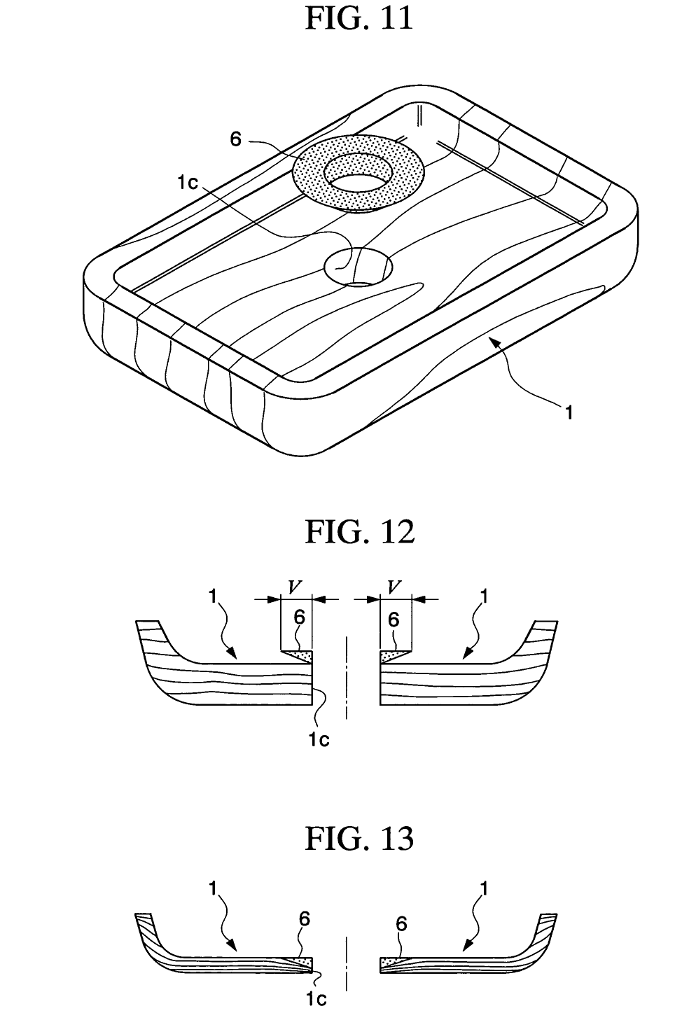

In the wood piece 1 of this fifth preferred embodiment, an aperture 1c is formed, just as was the case with the above described third or fourth preferred embodiment. In the state before compressing the wood piece 1, as shown in FIG. 12, an other member 6 made of material which is harder than wood (for example, a metal, a ceramic, or reinforced plastic) is disposed at a portion for which it is required to ensure high strength such as the edge around the hole 1c (denoted by V in the figure). The shape of this other member 6 is as shown in FIG. 11. The other member 6 is formed in a circular ring shape, with its portion around its inner peripheral surface being made the thickest, and with its thickness gradually diminishing towards its outer periphery. When a wood piece 1 as described above is strengthened according to the process which has been explained with reference to the above described first preferred embodiment, the wood piece 1 comes to be formed in a plate shape of almost uniform thickness as shown in FIG. 13. Looking at the wood piece 1 after compression, the portion for which it is required to ensure high strength is strengthened by the other member 6, and the compression ratio of the portion for which it is required to ensure high strength is higher than that of its surroundings. Therefore, the portion against which is positioned the other member 6 obtains a higher strength.

Furthermore, it is prevented from generating of a crack from this surface, and it is prevented from leaking out of sap from this surface which has been cut, which might otherwise cause a foul odor. It should be understood that this other member 6 may either be positioned against the interior aspect or against the exterior aspect of the wood piece 1.

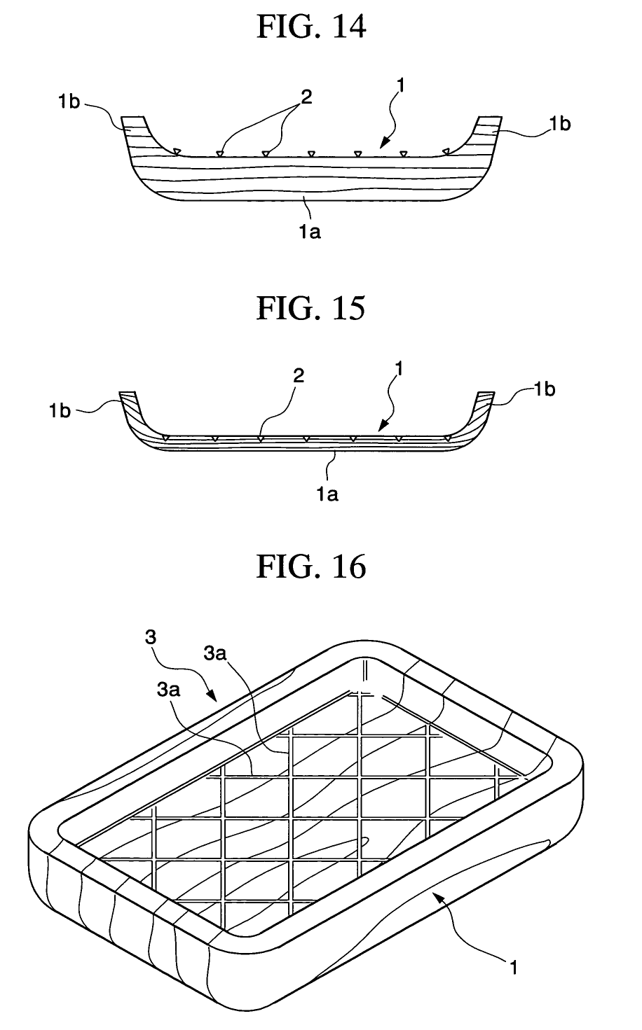

Next, the sixth preferred embodiment of the present invention will be explained with reference to FIG. 14 and FIG. 15. It should be understood that to structural elements which are the same as in the above described preferred embodiments and which have already been explained, the same reference symbols are appended, and their explanation will be curtailed.

In the wood piece 1 of this sixth preferred embodiment, a plurality of rod shaped members 2 which are made of metal are integrated with the wood piece 1. In the state before compressing the wood piece 1, as shown in FIG. 14, these rod shaped reinforcement members 2 are laid on the bottom surface of the interior surface of the wood piece 1, oriented so as to cross the grain of the wood piece 1, in parallel with approximately uniform intervals being left between them. When a wood piece 1 as described above is strengthened according to the process which has been explained with reference to the above described first preferred embodiment, the wood piece 1 is integrated with the rod shaped members 2 by compression as shown in FIG. 15. Therefore, a resultant strength is obtained for their integration is substantially higher than would have been obtained for the wood piece 1 on its own.

By arranging the rod shaped members 2 so as to cross the grain of the wood piece 1, it is difficult for splitting of the wood piece 1 to occur, even if shear forces from above and blow act upon the wood piece 1 at the locations separated in the direction which crosses its grain so as to attempt to split the wood piece 1. Furthermore, the workability of the wood piece I which has thus been strengthened by the rod shaped members 2 is also enhanced by the plastic deformation of the rod shaped members 2. Moreover, if the rod shaped members 2 made of metal are quenched, it is also possible further to enhance the strength of the resultant component, due to metal hardening of the rod shaped members 2.

In this connection, although in the above described sixth preferred embodiment the reinforcing member which is utilized is formed as the metallic rod shaped members 2, it would also be possible to utilize a net 3 which is made of metal, as shown in FIG. 16. Such a net 3 is made from a plurality of metallic wires 3a which extend in two directions which are almost perpendicular to one another, the net 3 is disposed with respect to the wood piece 1 so that metallic wires 3a thereof extending in any direction cross the grain of the wood piece 1.

Since the net 3 made of metal is utilized as the reinforcing member, and reinforces the wood piece 1 over its surface to which the net 3 conforms, the surface rigidity of the wood is enhanced. It should be understood that, instead of the net 3 made of metal, it would also be acceptable to utilize a punched metal sheet or the like which was made in the form of a grating, and the same benefits would be obtained.

Furthermore, although in the sixth preferred embodiment described above the rod shaped members 2 which are employed as the reinforcing member are made of metal, this is not to be considered as being limitative; it would also be possible to utilize reinforcement members which are made of some other suitable material which is harder than wood, and the same benefits would be obtained.

Next, the seventh preferred embodiment of the present invention will be explained with reference to FIG. 17. It should be understood that to structural elements which are the same as in the above described preferred embodiments and which have already been explained, the same reference symbols are appended, and their explanation will be curtailed.

In the wood piece 1 of this seventh preferred embodiment, as shown in FIG. 17, a synthetic resin 7 such as a plastic or an epoxy resin or the like is impregnated into the wood piece 1, and the entire mass of the wood piece 1 is further strengthened by this synthetic resin 7 which has been solidified after impregnation.

Since the synthetic resin 7 is impregnated the entire mass of the wood piece 1 and is solidified thereafter, it is possible to enhance the strength of the wood piece 1 extremely, without losing the excellent moisture absorption of the wood piece 1 as a natural material, and easiness of gripping in the hand, or without deteriorating the excellent feeling which appeals to the sensitivities.

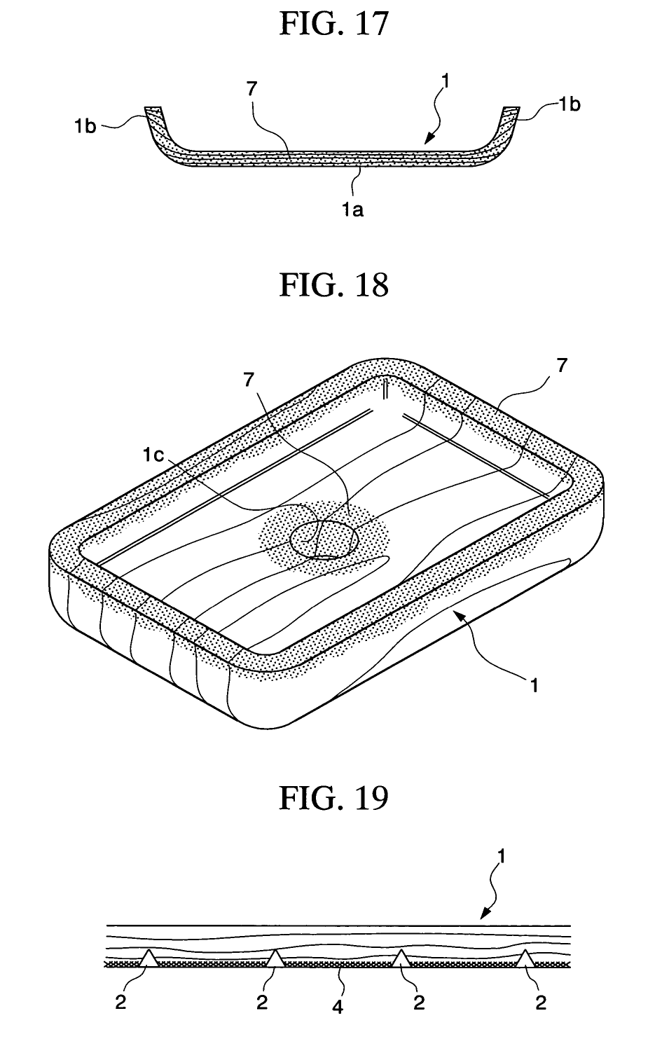

Next, the eighth preferred embodiment of the present invention will be explained with reference to FIG. 18. It should be understood that to structural elements which are the same as in the above described preferred embodiments and which have already been explained, the same reference symbols are appended, and their explanation will be curtailed.

In the wood piece 1 of this eighth preferred embodiment, an aperture 1c for exposing the imaging lens 13 is formed. After compression, as shown in FIG. 18, a synthetic resin 7 such as a plastic or an epoxy resin or the like is impregnated into the inner peripheral surface of this aperture 1c and into the rectangular end surface of the wall portion 1b of the wood piece 1, and these surfaces of the wood piece 1 are further strengthened by this synthetic resin 7 which has been solidified after impregnation.

Since the synthetic resin 7 is impregnated into the inner peripheral surface of this aperture 1c and into the rectangular end surface of the wall portion 1b and is solidified thereafter, it is possible to enhance the strength of the internal portions of the wood piece 1 at these surfaces and in their vicinities, without losing the excellent moisture absorption of the wood piece 1 as a natural material, and easiness of gripping in the hand, or without deteriorating the excellent feeling which appeals to the sensitivities.

Furthermore, it is prevented from generating of a crack from this surface, and it is prevented from leaking out of sap from this surface which has been cut, which might otherwise cause a foul odor. Moreover, it is prevented from deforming or rotting due to the absorption of moisture.

Next, the ninth preferred embodiment of the present invention will be explained with reference to FIG. 19. It should be understood that to structural elements which are the same as in the above described preferred embodiments and which have already been explained, the same reference symbols are appended, and their explanation will be curtailed.

In the wood piece 1 of this ninth preferred embodiment, after the wood piece 1 has been strengthened by the process which has been explained above with respect to the sixth preferred embodiment, a carbonized layer 4 of almost uniform thickness is formed at its surface where the rod shaped members 2 are provided. Although wood is originally a good insulator, it may be converted into a good conductor by being carbonized, and it then exhibits characteristics which are the same as or superior to those of metal, and moreover this wood piece 1 is extremely effective as a covering member for, for example, an electronic device, since, in comparison with a metal, it becomes a electromagnetic shielding material which is remarkably light in weight.

It should be understood that, while this carbonized layer 4 may be formed by burning one side of the wood piece 1, it should also be considered that deformation may occur if only one side of the wood piece 1 is burned, since the portion which has been burned shrinks, so that a dimensional discrepancy arises vis a vis the other side. To address this problem, it is effective to bum one side of the wood piece 1, while drying out the water component which is included in the other side thereof by heating that other side up to the temperature which is required for evaporating said water component, and then both sides of the wood piece 1 shrink together, so that the occurrence of deformation is avoided.

Although in this ninth preferred embodiment, rod shaped members 2 were integrated with the wood piece 1 as reinforcing member, there is no substantial change in function of the carbonized layer 4 as a shield against electromagnetic radiation even if no reinforcing member is incorporated.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

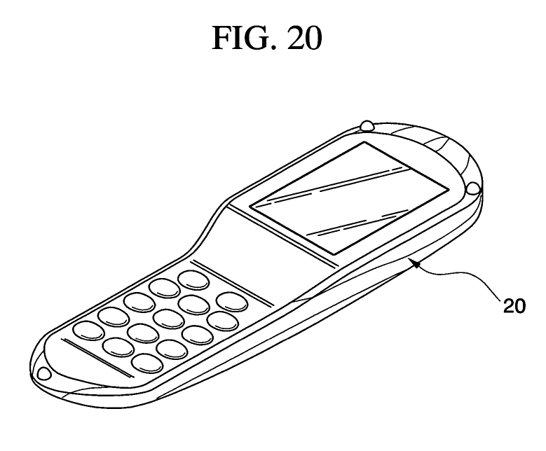

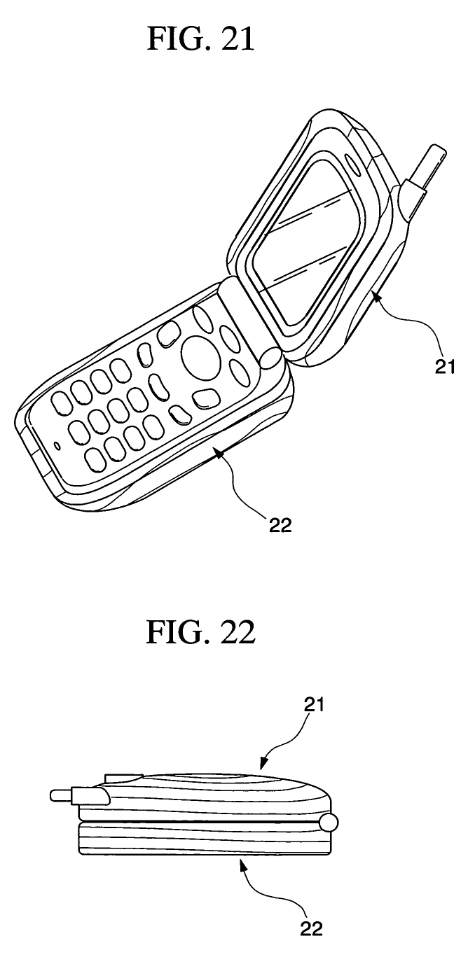

Although, in the description of these preferred embodiments of the present invention, a digital camera has been used as one example of an electronic device, the present invention may also be employed for using wood which has been strengthened as a material for making the covering member 20 of a remote control device for a household electrical product (for example, a television, a video recorder, an air conditioner, a projector, or the like) as shown for example in FIG. 20, or the covering members 21, 22 of a portable telephone fitted with a camera, as shown in FIG. 21 and FIG. 22. Furthermore, it is also suitable for any type of electronic device which is operated while being held in user's hand, such as an IC recorder, a PDA, or the like, although no examples thereof are shown in the figures.

1. A portable electronic device which is operated while being held in a hand of a user comprising a covering member made of a wood piece which has been strengthened.

2. An electronic device according to claim 1, wherein the wood piece is strengthened by compression.

3. An electronic device according to claim 2, wherein the wood piece is compressed after a high density portion of the wood piece has been made thin and a low density portion of the wood piece has been made thick.

4. An electronic device according to claim 2, wherein the wood piece is compressed after a portion of the wood piece at which high strength must be ensured has been made thicker than a surrounding portion thereof.

5. An electronic device according to claim 2, wherein the wood piece is compressed after another wood piece has been adhered to a portion of the wood piece at which high strength must be ensured.

6. An electronic device according to claim 5, wherein the direction of the grain of the wood piece and the direction of the grain of the another wood piece are different.

7. An electronic device according to claim 2, further comprising another member which is harder than the wood piece and is disposed on a portion of the wood piece at which high strength must be ensured,
wherein, the wood piece is compressed together with the another member.

8. An electronic device according to claim 1, wherein the wood piece is strengthened by being integrated with a reinforcing member which is harder than the wood piece, in such a manner that the wood piece is superimposed upon the reinforcing member and is compressed therewith.

9. An electronic device according to claim 8, wherein the reinforcing member is of metal.

10. An electronic device according to claim 8, wherein the direction along which the reinforcing member extends and the direction of the grain of the wood piece cross one another.

11. An electronic device according to claim 8, wherein the reinforcing member is made in the form of a grating or a net.

12. An electronic device according to claim 9, wherein the reinforcing member is quenched.

13. An electronic device according to claim 1, wherein the wood piece is cut across its grain, and a synthetic resin is impregnated into a end surface of the wood piece which is formed by this cutting.

14. An electronic device according to claim 1, wherein the wood piece is strengthened by being impregnated with a synthetic resin.

15. An electronic device according to claim 1, wherein a carbonized layer is formed on a surface of the wood piece.
